(19) United States
(12) Patent Application Publication
(10) Pub. No.: US 2026/0127559 A1
(43) Pub. Date: May 7, 2026

(54) TRAINING OF VISION DETECTION SYSTEMS USING RFID TAGS

(71) Applicant: Impinj, Inc., Seattle, WA (US)

(72) Inventor: Christopher J. DIORIO, Shoreline, WA (US)

(73) Assignee: Impinj, Inc., Seattle, WA (US)

(21) Appl. No.: 19/484,957

(22) PCT Filed: May 16, 2024
(86) PCT No.: PCT/US2024/029652

§ 371 Date: Nov. 17, 2025

Related U.S. Application Data
(60) Provisional application No. 63/502,976, filed on May 18, 2023.

(51) Int. Cl. G06Q 10/30; G06K 7/10; G06V 10/764; G06V 10/774; G06V 10/82; G06V 20/52

(52) U.S. Cl. CPC G06Q 10/30; G06K 7/10297; G06V 10/764; G06V 10/7753; G06V 10/82; G06V 20/52

(57) ABSTRACT

A recycling-material sorting system includes an image capture system, an RFID reader system, and a vision detection system. A controller receives item identifier information from an RFID IC associated with a recyclable item through the RFID reader system. If the controller is able to derive recycling information for the recyclable item, it is used to sort the recyclable item. The item identifier information is further used to train a vision detection system regardless of whether the recycling information can be derived for the recyclable item or not.

### CROSS-REFERENCE TO RELATED APPLICATIONS

This application claims the benefit of U.S. Provisional Patent Application Ser. No. 63/502,976 filed on May 18, 2023. The disclosures of the provisional application are hereby incorporated by reference for all purposes.

### BACKGROUND OF THE INVENTION

One of the approaches to address worsening environmental challenges is to increase recycling. Different types of recyclable items need to be processed differently. One approach is to ask consumers and other refuse producers to sort their recyclables before collection. Another approach is single-stream recycling, where multiple types of recyclables such as newspaper, cardboard, plastic, aluminum, are placed in a single container for recycling. These recyclables are collected and taken to a recycling facility to be sorted. The challenge with single stream recycling is sorting the recyclables at the recycling facility with reasonable cost.

Radio-Frequency Identification (RFID) systems typically include RFID readers, also known as RFID reader/writers or RFID interrogators, and RFID tags. RFID systems can be used in many ways for locating and identifying objects to which the tags are attached. RFID systems are useful in product-related and service-related industries for tracking objects being processed, inventoried, or handled. In such cases, an RFID tag is usually attached to an individual item, or to its package. The RFID tag typically includes, or is, a radio-frequency (RF) integrated circuit (IC).

In principle, RFID techniques entail using an RFID reader to inventory one or more RFID tags, where inventorying involves singulating a tag, receiving an identifier from a tag, and/or acknowledging a received identifier (e.g., by transmitting an acknowledge command). “Singulated” is defined as a reader singling-out one tag, potentially from among multiple tags, for a reader-tag dialog. “Identifier” is defined as a number identifying the tag or the item to which the tag is attached, such as a tag identifier (TID), electronic product code (EPC), etc. An “inventory round” is defined as a reader staging RFID tags for successive inventorying. The reader transmitting an RF wave performs the inventory. The RF wave is typically electromagnetic, at least in the far field. The RF wave can also be predominantly electric or magnetic in the near or transitional near field. The RF wave may encode one or more commands that instruct the tags to perform one or more actions. The operation of an RFID reader sending commands to an RFID tag is sometimes known as the reader “interrogating” the tag.

In typical RFID systems, an RFID reader transmits a modulated RF inventory signal (a command), receives a tag reply, and transmits an RF acknowledgement signal responsive to the tag reply. A tag that replies to the interrogating RF wave does so by transmitting back another RF wave. The tag either generates the transmitted back RF wave originally, or by reflecting back a portion of the interrogating RF wave in a process known as backscatter. Backscatter may take place in a number of ways.

The reflected-back RF wave may encode data stored in the tag, such as a number. The response is demodulated and decoded by the reader, which thereby identifies, counts, or otherwise interacts with the associated item. The decoded data can denote a serial number, a price, a date, a time, a destination, an encrypted message, an electronic signature, other attribute(s), any combination of attributes, and so on. Accordingly, when a reader receives tag data it can learn about the item that hosts the tag and/or about the tag itself.

An RFID tag typically includes an antenna section, a radio section, a power-management section, and frequently a logical section, a memory, or both. In some RFID tags the power-management section includes an energy storage device such as a battery. RFID tags with an energy storage device are known as battery-assisted, semi-active, or active tags. Other RFID tags can be powered solely by the RF signal they receive. Such RFID tags do not include an energy storage device and are called passive tags. Of course, even passive tags typically include temporary energy-and data/flag-storage elements such as capacitors or inductors.

### SUMMARY OF THE INVENTION

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Examples are directed to using RFID systems for recyclable sorting. In a single stream recycling facility, mixed recyclable items are sorted into groups of items that can be processed together. The sorting may involve RFID systems and/or vision detection. For example, recyclable items may have associated RFID tags. An RFID system (e.g., one or more RFID readers and/or an RFID network) may read RFID tags associated with the recyclable items and provide recycling information to a sorting system for the items to be sorted accordingly. In situations where the recyclable items do not have associated RFID tags, other means of distinguishing between different recyclable items, such as vision detection, may be used to sort the material. Such distinguishing means may involve a machine learning algorithm that learns and identifies different types of recyclable items. If the sorting involves both RFID systems and other distinguishing means (e.g., vision detection), the recyclable item identification information retrieved by the RFID systems may be used to train the machine learning algorithms used by the other distinguishing means, thereby improving the accuracy of the distinguishing means.

Some RFID tags may be in a public mode, allowing the RFID system to readily retrieve item-related or material-related information. Other RFID tags may be in a privacy mode and therefore may not provide their information without proper authentication. For such scenarios, the RFID tags may be configured for a recycling-enabled privacy mode, where such an RFID tag may not respond to commands unless a previous command either (a) includes correct verification information or (b) specifies a recycling indicator of the RFID tag. For example, a reader of the RFID system may transmit a command specifying a recycling indicator of the RFID tag. The RFID tag then responds to the RFID reader, allowing the reader to retrieve recycling information from and/or estimate the location of the tag. The recycling and location information may then be used to sort the tag's associated item. If the recycling system includes other distinguishing means (e.g., a vision detection system) based on machine learning algorithms, then the recycling and location information may also be used as training set data to train the supervised machine learning algorithms.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

The following Detailed Description proceeds with reference to the accompanying drawings, in which:

FIG. 1 is a block diagram of components of an RFID system.

FIG. 2 is a diagram showing components of a passive RFID tag, such as a tag that can be used in the system of FIG. 1.

FIG. 3 is a conceptual diagram for explaining a half-duplex mode of communication between the components of the RFID system of FIG. 1.

FIG. 4 is a block diagram showing a detail of an RFID tag, such as the one shown in FIG. 2.

FIGS. 5A and 5B illustrate signal paths during tag-to-reader and reader-to-tag communications in the block diagram of FIG. 4.

FIG. 6 is a block diagram showing a detail of an RFID reader system, such as the one shown in FIG. 1.

FIG. 7 depicts a recycling system, according to examples.

FIG. 8 depicts a block diagram of how RFID-derived information may be used to train vision detection, according to examples.

FIG. 9 depicts a diagram of RFID-assisted vision detection training for sorting recyclable items, according to examples.

FIG. 10 illustrates interactions between an RFID reader and an RFID tag in possible modes including a recycling-enabled privacy mode, according to examples.

FIG. 11 is a flow diagram illustrating an example method for RFID-assisted training of vision-detection-based sorting of recyclable items, according to examples.

FIG. 12 illustrates a block diagram of an example computer program product, according to examples.

### DETAILED DESCRIPTION OF THE INVENTION

In the following detailed description, references are made to the accompanying drawings that form a part hereof, and in which are shown by way of illustration specific examples. These examples may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

As used herein, “memory” is one of ROM, RAM, SRAM, DRAM, NVM, EEPROM, FLASH, Fuse, MRAM, FRAM, and other similar volatile and nonvolatile information-storage technologies. Some portions of memory may be writeable and some not. “Instruction” refers to a request to a tag to perform a single explicit action (e.g., write data into memory). “Command” refers to a reader request for one or more tags to perform one or more actions, and includes one or more tag instructions preceded by a command identifier or command code that identifies the command and/or the tag instructions. “Program” refers to a request to a tag to perform a set or sequence of instructions (e.g., read a value from memory and, if the read value is less than a threshold then lock a memory word). “Protocol” refers to an industry standard for communications between a reader and a tag (and vice versa), such as the Class-1 Generation-2 UHF RFID Protocol for Communications at 860 MHz-960 MHz by GS1 EPCglobal, Inc. (“Gen2 Protocol”), versions 1.2.0, 2.0, and 3.0 of which are hereby incorporated by reference.

RFID system users understandably have privacy concerns regarding access to RFID tag IC data. For example, a consumer that has purchased an item with an RFID tag IC may not want random RFID readers to be able to retrieve information from the RFID tag IC. One potential solution is to allow RFID tag ICs to enter a “privacy mode.” When an RFID tag IC is in the privacy mode, it will only respond to commands from authorized RFID readers and will ignore commands from unauthorized RFID readers. Several examples of privacy modes are described in commonly assigned U.S. Pat. No. 10,402,710, issued on Sep. 3, 2019, hereby incorporated by reference in its entirety.

RFID tag ICs may have different kinds of privacy modes. In one privacy mode, an RFID tag IC may not respond to any unauthorized RFID readers. In another privacy mode, an RFID tag IC may only respond to certain commands, with limited information.

As an example of the latter, suppose that an RFID tag IC stores information about how an associated item can be recycled or disposed of. Such information, referred to as recycling information, may include item classification, item composition, handling instructions, potential hazards, or other similar information. A consumer, upon purchasing the item, places the tag IC into a recycling-enabled privacy mode. At some later time, the consumer discards the item, but neglects to take the tag IC out of the privacy mode. In this case, because the privacy mode is recycling-enabled, an RFID reader may be able to retrieve recycling information from the tag IC. However, the RFID reader would not be able to retrieve other, non-recycling-related information from the tag IC.

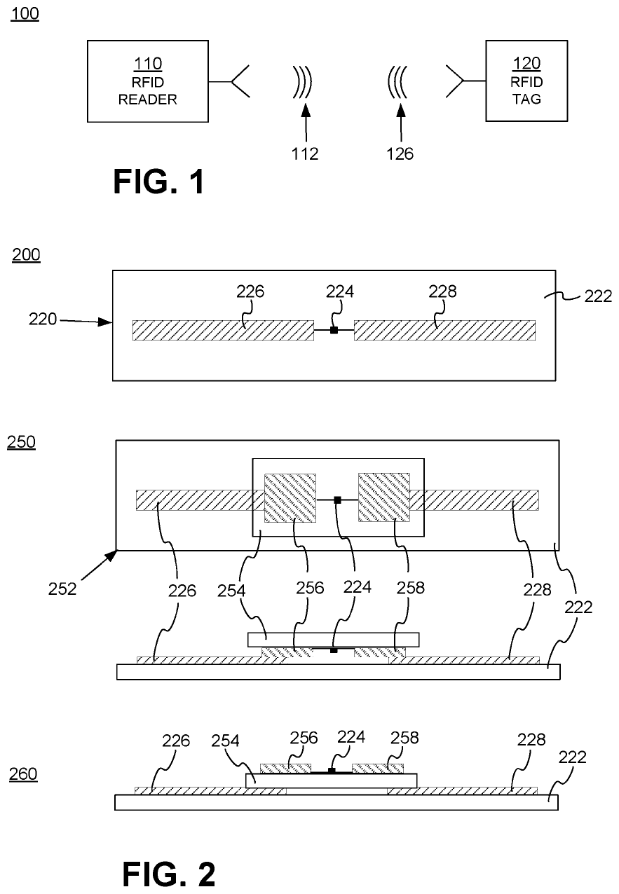

FIG. 1 is a diagram of the components of a typical RFID system 100, incorporating examples. An RFID reader 110 and a nearby RFID tag 120 communicate via RF signals 112 and 126. When sending data to tag 120, reader 110 may generate RF signal 112 by encoding the data, modulating an RF waveform with the encoded data, and transmitting the modulated RF waveform as RF signal 112. In turn, tag 120 may receive RF signal 112, demodulate encoded data from RF signal 112, and decode the encoded data. Similarly, when sending data to reader 110 tag 120 may generate RF signal 126 by encoding the data, modulating an RF waveform with the encoded data, and causing the modulated RF waveform to be sent as RF signal 126. The data sent between reader 110 and tag 120 may be represented by symbols, also known as RFID symbols. A symbol may be a delimiter, a calibration value, or implemented to represent binary data, such as “0” and “1”, if desired. Upon processing by reader 110 and tag 120, symbols may be treated as values, numbers, or any other suitable data representations.

The RF waveforms transmitted by reader 110 and/or tag 120 may be in a suitable range of frequencies, such as those near 900 MHz, 13.56 MHz, or similar. In some examples, RF signals 112 and/or 126 may include non-propagating RF signals, such as reactive near-field signals or similar. RFID tag 120 may be active or battery-assisted (i.e., possessing its own power source), or passive. In the latter case, RFID tag 120 may harvest power from RF signal 112.

FIG. 2 is a diagram of an RFID tag 220, which may function as tag 120 of FIG. 1. Tag 220 may be formed on a substantially planar inlay 222, which can be made in any suitable way. Tag 220 includes a circuit which may be implemented as an IC 224. In some examples IC 224 is fabricated in complementary metal-oxide semiconductor (CMOS) technology. In other examples IC 224 may be fabricated in other technologies such as bipolar junction transistor (BJT) technology, metal-semiconductor field-effect transistor (MESFET) technology, and others as will be well known to those skilled in the art. IC 224 is arranged on inlay 222.

Tag 220 also includes an antenna for transmitting and/or interacting with RF signals. In some examples the antenna can be etched, deposited, and/or printed metal on inlay 222; conductive thread formed with or without substrate 222; nonmetallic conductive (such as graphene) patterning on substrate 222; a first antenna coupled inductively, capacitively, or galvanically to a second antenna; or can be fabricated in myriad other ways that exist for forming antennas to receive RF waves. In some examples the antenna may even be formed in IC 224. Regardless of the antenna type, IC 224 is electrically coupled to the antenna via suitable IC contacts (not shown in FIG. 2). The term “electrically coupled” as used herein may mean a direct electrical connection, or it may mean a connection that includes one or more intervening circuit blocks, elements, or devices. The “electrical” part of the term “electrically coupled” as used in this document shall mean a coupling that is one or more of ohmic/galvanic, capacitive, and/or inductive. Similarly, the terms “electrically isolated” or “electrically decoupled” as used herein mean that electrical coupling of one or more types (e.g., galvanic, capacitive, and/or inductive) is not present, at least to the extent possible. For example, elements that are electrically isolated from each other are galvanically isolated from each other, capacitively isolated from each other, and/or inductively isolated from each other. Of course, electrically isolated components will generally have some unavoidable stray capacitive or inductive coupling between them, but the intent of the isolation is to minimize this stray coupling when compared with an electrically coupled path.

IC 224 is shown with a single antenna port, comprising two IC contacts electrically coupled to two antenna segments 226 and 228 which are shown here forming a dipole. Many other examples are possible using any number of ports, contacts, antennas, and/or antenna segments. Antenna segments 226 and 228 are depicted as separate from IC 224, but in other examples the antenna segments may alternatively be formed on IC 224. Tag antennas according to examples may be designed in any form and are not limited to dipoles. For example, the tag antenna may be a patch, a slot, a loop, a coil, a horn, a spiral, a monopole, microstrip, stripline, or any other suitable antenna.

Diagram 250 depicts top and side views of tag 252, formed using a strap. Tag 252 differs from tag 220 in that it includes a substantially planar strap substrate 254 having strap contacts 256 and 258. IC 224 is mounted on strap substrate 254 such that the IC contacts on IC 224 electrically couple to strap contacts 256 and 258 via suitable connections (not shown). Strap substrate 254 is then placed on inlay 222 such that strap contacts 256 and 258 electrically couple to antenna segments 226 and 228. Strap substrate 254 may be affixed to inlay 222 via pressing, an interface layer, one or more adhesives, or any other suitable means.

Diagram 260 depicts a side view of an alternative way to place strap substrate 254 onto inlay 222. Instead of strap substrate 254′s surface, including strap contacts 256/258, facing the surface of inlay 222, strap substrate 254 is placed with its strap contacts 256/258 facing away from the surface of inlay 222. Strap contacts 256/258 can then be either capacitively coupled to antenna segments 226/228 through strap substrate 254, or conductively coupled using a through-via which may be formed by crimping strap contacts 256/258 to antenna segments 226/228. In some examples, the positions of strap substrate 254 and inlay 222 may be reversed, with strap substrate 254 mounted beneath inlay 222 and strap contacts 256/258 electrically coupled to antenna segments 226/228 through inlay 222. Of course, in yet other examples strap contacts 256/258 may electrically couple to antenna segments 226/228 through both inlay 222 and strap substrate 254.

In operation, the antenna couples with RF signals in the environment and propagates the signals to IC 224, which may both harvest power and respond if appropriate, based on the incoming signals and the IC's internal state. If IC 224 uses backscatter modulation, then it may generate a response signal (e.g., signal 126) from an RF signal in the environment (e.g., signal 112) by modulating the antenna's reflectance. Electrically coupling and uncoupling the IC contacts of IC 224 can modulate the antenna's reflectance, as can varying the admittance or impedance of a shunt-connected or series-connected circuit element which is coupled to the IC contacts. If IC 224 is capable of transmitting signals (e.g., has its own power source, is coupled to an external power source, and/or can harvest sufficient power to transmit signals), then IC 224 may respond by transmitting response signal 126. In the examples of FIG. 2, antenna segments 226 and 228 are separate from IC 224. In other examples, the antenna segments may alternatively be formed on IC 224.

An RFID tag such as tag 220 is often attached to or associated with an individual item or the item packaging. An RFID tag may be fabricated and then attached to the item or packaging, may be partly fabricated before attachment to the item or packaging and then completely fabricated upon attachment to the item or packaging, or the manufacturing process of the item or packaging may include the fabrication of the RFID tag. In some examples, the RFID tag may be integrated into the item or packaging. In this case, portions of the item or packaging may serve as tag components. For example, conductive item or packaging portions may serve as tag antenna segments or contacts. Nonconductive item or packaging portions may serve as tag substrates or inlays. If the item or packaging includes integrated circuits or other circuitry, some portion of the circuitry may be configured to operate as part or all of an RFID tag IC. Thus, an “RFID IC” need not be distinct from an item, but more generally refers to the item containing an RFID IC and antenna capable of interacting with RF waves and receiving and responding to RFID signals. Because the boundaries between IC, tag, and item are thus often blurred, the term “RFID IC”, “RFID tag”, “tag”, or “tag IC” as used herein may refer to the IC, the tag, or even to the item as long as the referenced element is capable of RFID functionality.

The components of the RFID system of FIG. 1 may communicate with each other in any number of modes. One such mode is called full duplex, where both reader 110 and tag 120 can transmit at the same time. In some examples, RFID system 100 may be capable of full duplex communication. Another such mode, which may be more suitable for passive tags, is called half-duplex, and is described below.

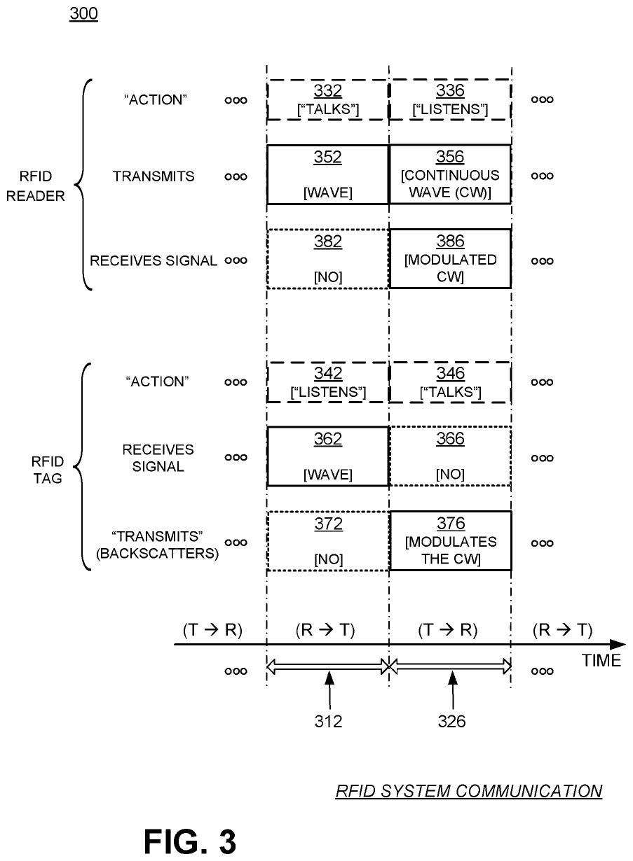

FIG. 3 is a conceptual diagram 300 for explaining half-duplex communications between the components of the RFID system of FIG. 1, in this case with tag 120 implemented as a passive tag. The explanation is made with reference to a TIME axis, and also to a human metaphor of “talking” and “listening”. The actual technical implementations for “talking” and “listening” are now described.

In a half-duplex communication mode, RFID reader 110 and RFID tag 120 talk and listen to each other by taking turns. As seen on axis TIME, reader 110 talks to tag 120 during intervals designated “R->T”, and tag 120 talks to reader 110 during intervals designated “T->R”. For example, a sample R->T interval occurs during time interval 312, during which reader 110 talks (block 332) and tag 120 listens (block 342). A following sample T->R interval occurs during time interval 326, during which reader 110 listens (block 336) and tag 120 talks (block 346). Interval 312 may be of a different duration than interval 326—here the durations are shown approximately equal only for purposes of illustration.

During interval 312, reader 110 transmits a signal such as signal 112 described in FIG. 1 (block 352), while tag 120 receives the reader signal (block 362), processes the reader signal to extract data, and harvests power from the reader signal. While receiving the reader signal, tag 120 does not backscatter (block 372), and therefore reader 110 does not receive a signal from tag 120 (block 382).

During interval 326, also known as a backscatter time interval or backscatter interval, reader 110 does not transmit a data-bearing signal. Instead, reader 110 transmits a continuous wave (CW) signal, which is a carrier that generally does not encode information. The CW signal provides energy for tag 120 to harvest as well as a waveform that tag 120 can modulate to form a backscatter response signal. Accordingly, during interval 326 tag 120 is not receiving a signal with encoded information (block 366) and instead modulates the CW signal (block 376) to generate a backscatter signal such as signal 126 described in FIG. 2. Tag 120 may modulate the CW signal to generate a backscatter signal by adjusting its antenna reflectance, as described above. Reader 110 then receives and processes the backscatter signal (block 386).

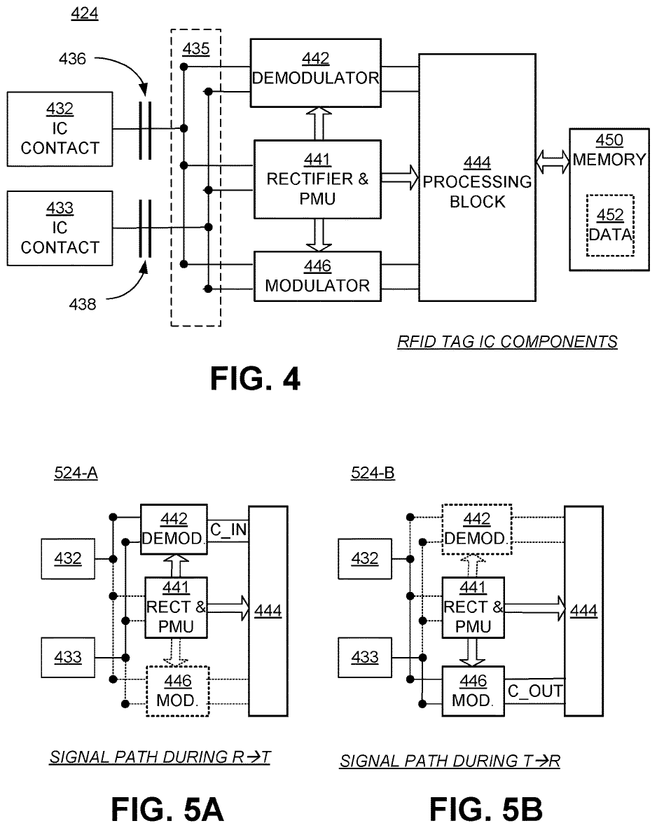

FIG. 4 is a block diagram showing a detail of an RFID IC, such as IC 224 in FIG. 2. Electrical circuit 424 may be implemented in an IC, such as IC 224. Circuit 424 implements at least two IC contacts 432 and 433, suitable for coupling to antenna segments such as antenna segments 226/228 in FIG. 2. When two IC contacts form the signal input from and signal return to an antenna they are often referred-to as an antenna port. IC contacts 432 and 433 may be made in any suitable way, such as from electrically-conductive pads, bumps, or similar. In some examples circuit 424 implements more than two IC contacts, especially when configured with multiple antenna ports and/or to couple to multiple antennas.

Circuit 424 includes signal-routing section 435 which may include signal wiring, signal-routing busses, receive/transmit switches, and similar that can route signals between the components of circuit 424. IC contacts 432/433 may couple galvanically, capacitively, and/or inductively to signal-routing section 435. For example, optional capacitors 436 and/or 438 may capacitively couple IC contacts 432/433 to signal-routing section 435, thereby galvanically decoupling IC contacts 432/433 from signal-routing section 435 and other components of circuit 424.

Capacitive coupling (and the resultant galvanic decoupling) between IC contacts 432 and/or 433 and components of circuit 424 is desirable in certain situations. For example, in some RFID tag examples IC contacts 432 and 433 may galvanically connect to terminals of a tuning loop on the tag. In these examples, galvanically decoupling IC contact 432 from IC contact 433 may prevent the formation of a DC short circuit between the IC contacts through the tuning loop.

Capacitors 436/438 may be implemented within circuit 424 and/or partly or completely external to circuit 424. For example, a dielectric or insulating layer on the surface of the IC containing circuit 424 may serve as the dielectric in capacitor 436 and/or capacitor 438. As another example, a dielectric or insulating layer on the surface of a tag substrate (e.g., inlay 222 or strap substrate 254) may serve as the dielectric in capacitors 436/438. Metallic or conductive layers positioned on both sides of the dielectric layer (i.e., between the dielectric layer and the IC and between the dielectric layer and the tag substrate) may then serve as terminals of the capacitors 436/438. The conductive layers may include IC contacts (e.g., IC contacts 432/433), antenna segments (e.g., antenna segments 226/228), or any other suitable conductive layers.

Circuit 424 includes a rectifier and PMU (Power Management Unit) 441 that harvests energy from the RF signal incident on antenna segments 226/228 to power the circuits of IC 424 during either or both reader-to-tag (R->T) and tag-to-reader (T->R) intervals. Rectifier and PMU 441 may be implemented in any way known in the art and may include one or more components configured to convert an alternating-current (AC) or time-varying signal into a direct-current (DC) or substantially time-invariant signal.

Circuit 424 also includes a demodulator 442, a processing block 444, a memory 450, and a modulator 446. Demodulator 442 demodulates the RF signal received via IC contacts 432/433, and may be implemented in any suitable way, for example using a slicer, an amplifier, and other similar components. Processing block 444 receives the output from demodulator 442, performs operations such as command decoding, memory interfacing, and other related operations, and may generate an output signal for transmission. Processing block 444 may be implemented in any suitable way, for example by combinations of one or more of a processor, memory, decoder, encoder, and other similar components. Memory 450 stores data 452 and may be at least partly implemented as permanent or semi-permanent memory such as nonvolatile memory (NVM), EEPROM, ROM, or other memory types configured to retain data 452 even when circuit 424 does not have power. Processing block 444 may be configured to read data from and/or write data to memory 450.

Modulator 446 generates a modulated signal from the output signal generated by processing block 444. In one embodiment, modulator 446 generates the modulated signal by driving the load presented by antenna segment(s) coupled to IC contacts 432/433 to form a backscatter signal as described above. In another embodiment, modulator 446 includes and/or uses a transmitter to generate and transmit the modulated signal via antenna segment(s) coupled to IC contacts 432/433. Modulator 446 may be implemented in any suitable way, for example using a switch, driver, amplifier, and other similar components. Demodulator 442 and modulator 446 may be separate components, combined in a single transceiver circuit, and/or part of processing block 444.

In some examples, particularly in those with more than one antenna port, circuit 424 may contain multiple demodulators, rectifiers, PMUs, modulators, processing blocks, and/or memories.

FIG. 5A shows version 524-A of components of circuit 424 of FIG. 4, further modified to emphasize a signal operation during a R->T interval (e.g., time interval 312 of FIG. 3). During the R->T interval, demodulator 442 demodulates an RF signal received from IC contacts 432/433. The demodulated signal is provided to processing block 444 as C_IN, which in some examples may include a received stream of symbols. Rectifier and PMU 441 may be active, for example harvesting power from an incident RF waveform and providing power to demodulator 442, processing block 444, and other circuit components. During the R->T interval, modulator 446 is not actively modulating a signal, and in fact may be decoupled from the RF signal. For example, signal routing section 435 may be configured to decouple modulator 446 from the RF signal, or an impedance of modulator 446 may be adjusted to decouple it from the RF signal.

FIG. 5B shows version 524-B of components of circuit 424 of FIG. 4, further modified to emphasize a signal operation during a T->R interval (e.g., time interval 326 of FIG. 3). During the T->R interval, processing block 444 outputs a signal C_OUT, which may include a stream of symbols for transmission. Modulator 446 then generates a modulated signal from C_OUT and sends the modulated signal via antenna segment(s) coupled to IC contacts 432/433, as described above. During the T->R interval, rectifier and PMU 441 may be active, while demodulator 442 may not be actively demodulating a signal. In some examples, demodulator 442 may be decoupled from the RF signal during the T->R interval. For example, signal routing section 435 may be configured to decouple demodulator 442 from the RF signal, or an impedance of demodulator 442 may be adjusted to decouple it from the RF signal.

In typical examples, demodulator 442 and modulator 446 are operable to demodulate and modulate signals according to a protocol, such as the Gen2 Protocol mentioned above. In examples where circuit 424 includes multiple demodulators modulators, and/or processing blocks, each may be configured to support different protocols or different sets of protocols. A protocol specifies, in part, symbol encodings, and may include a set of modulations, rates, timings, or any other parameter associated with data communications. A protocol can be a variant of an internationally ratified protocol such as the Gen2 Protocol, for example including fewer or additional commands than the ratified protocol calls for, and so on. In some instances, additional commands may sometimes be called custom commands.

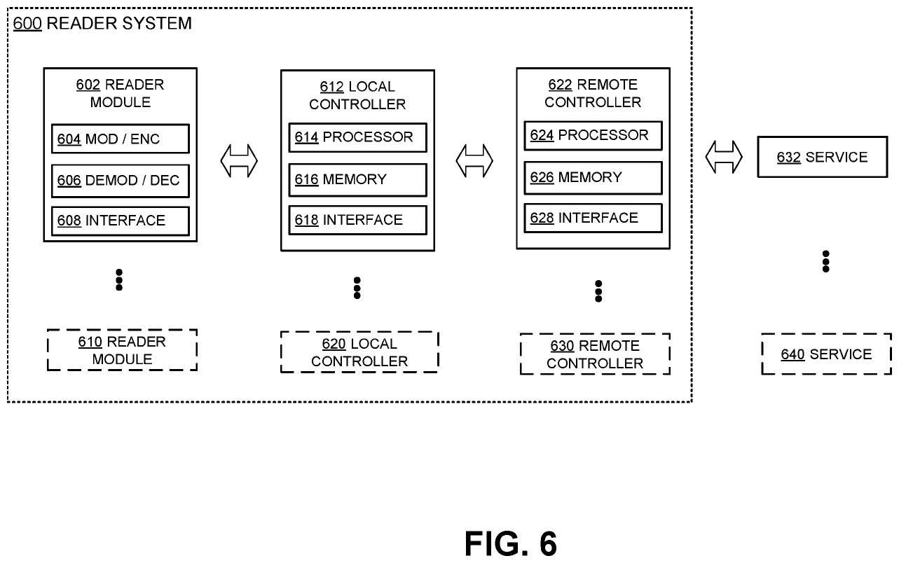

FIG. 6 depicts an RFID reader system 600 according to examples. Reader system 600 is configured to communicate with RFID tags and optionally to communicate with entities external to reader system 600, such as a service 632. Reader system 600 includes at least one reader module 602, configured to transmit signals to and receive signals from RFID tags. Reader system 600 further includes at least one local controller 612, and in some examples includes at least one remote controller 622. Controllers 612 and/or 622 are configured to control the operation of reader module 602, process data received from RFID tags communicating through reader module 602, communicate with external entities such as service 632, and otherwise control the operation of reader system 600.

In some examples, reader system 600 may include multiple reader modules, local controllers, and/or remote controllers. For example, reader system 600 may include at least one other reader module 610, at least one other local controller 620, and/or at least one other remote controller 630. A single reader module may communicate with multiple local and/or remote controllers, a single local controller may communicate with multiple reader modules and/or remote controllers, and a single remote controller may communicate with multiple reader modules and/or local controllers. Similarly, reader system 600 may be configured to communicate with multiple external entities, such as other reader systems (not depicted) and multiple services (for example, services 632 and 640).

Reader module 602 includes a modulator/encoder block 604, a demodulator/decoder block 606, and an interface block 608. Modulator/encoder block 604 may encode and modulate data for transmission to RFID tags. Demodulator/decoder block 606 may demodulate and decode signals received from RFID tags to recover data sent from the tags. The modulation, encoding, demodulation, and decoding may be performed according to a protocol or specification, such as the Gen2 Protocol. Reader module 602 may use interface block 608 to communicate with local controller 612 and/or remote controller 622, for example to exchange tag data, receive instructions or commands, or to exchange other relevant information.

Reader module 602 and blocks 604/606 are coupled to one or more antennas and/or antenna drivers (not depicted), for transmitting and receiving RF signals. In some examples, reader module 602 is coupled to multiple antennas and/or antenna drivers. In these examples, reader module 602 may transmit and/or receive RF signals on the different antennas in any suitable scheme. For example, reader module 602 may switch between different antennas to transmit and receive RF signals, transmit on one antenna but receive on another antenna, or transmit and/or receive on multiple antennas simultaneously. In some examples, reader module 602 may be coupled to one or more phased-array or synthesized-beam antennas whose beams can be generated and/or steered, for example by reader module 602, local controller 612, and/or remote controller 622.

Modulator/encoder block 604 and/or demodulator/decoder block 606 may be configured to perform conversion between analog and digital signals. For example, modulator/encoder block 604 may convert a digital signal received via interface block 608 to an analog signal for subsequent transmission, and demodulator/decoder block 606 may convert a received analog signal to a digital signal for transmission via interface block 608.

Local controller 612 includes a processor block 614, a memory 616, and an interface 618. Remote controller 622 includes a processor block 624, a memory 626, and an interface 628. Local controller 612 differs from remote controller 622 in that local controller 612 is collocated or at least physically near reader module 602, whereas remote controller 622 is not physically near reader module 602.

Processor blocks 614 and/or 624 may be configured to, alone or in combination, provide different functions. Such functions may include the control of other components, such as memory, interface blocks, reader modules, and similar; communication with other components such as reader module 620, other reader systems, services 632/640, and similar; data-processing or algorithmic processing such as encryption, decryption, authentication, and similar; or any other suitable function. In some examples, processor blocks 614/624 may be configured to convert analog signals to digital signals or vice-versa, as described above in relation to blocks 604/606; processor blocks 614/624 may also be configured to perform any suitable analog signal processing or digital signal processing, such as filtering, carrier cancellation, noise determination, and similar.

Processor blocks 614/624 may be configured to provide functions by execution of instructions or applications, which may be retrieved from memory (for example, memory 616 and/or 626) or received from some other entity. Processor blocks 614/624 may be implemented in any suitable way. For example, processor blocks 614/624 may be implemented using digital and/or analog processors such as microprocessors and digital-signal processors (DSPs); controllers such as microcontrollers; software running in a machine such as a general purpose computer; programmable circuits such as field programmable gate arrays (FPGAs), field-programmable analog arrays (FPAAs), programmable logic devices (PLDs), application specific integrated circuits (ASIC), any combination of one or more of these; and equivalents.

Memories 616/626 are configured to store information, and may be implemented in any suitable way, such as the memory types described above, any combination thereof, or any other known memory or information storage technology. Memories 616/626 may be implemented as part of their associated processor blocks (e.g., processor blocks 614/624) or separately. Memories 616/626 may store instructions, programs, or applications for processor blocks 614/624 to execute. Memories 616/626 may also store other data, such as files, media, component configurations or settings, etc.

In some examples, memories 616/626 store tag data. Tag data may be data read from tags, data to be written to tags, and/or data associated with tags or tagged items. Tag data may include identifiers for tags such as electronic product codes (EPCs), tag identifiers (TIDs), or any other information suitable for identifying individual tags. Tag data may also include tag passwords, tag profiles, tag cryptographic keys (secret or public), tag key generation algorithms, and any other suitable information about tags or items associated with tags.

Memories 616/626 may also store information about how reader system 600 is to operate. For example, memories 616/626 may store information about algorithms for encoding commands for tags, algorithms for decoding signals from tags, communication and antenna operating modes, encryption/authentication algorithms, tag location and tracking algorithms, cryptographic keys and key pairs (such as public/private key pairs) associated with reader system 600 and/or other entities, electronic signatures, and similar.

Interface blocks 608, 618, and 628 are configured to communicate with each other and with other suitably configured interfaces. The communications between interface blocks occur via the exchange of signals containing data, instructions, commands, or any other suitable information. For example, interface block 608 may receive data to be written to tags, information about the operation of reader module 602 and its constituent components, and similar; and may send data read from tags. Interface blocks 618 and 628 may send and receive tag data, information about the operation of other components, other information for enabling local controller 612 and remote controller 622 to operate in conjunction, and similar. Interface blocks 608/618/628 may also communicate with external entities, such as services 632, 640, other services, and/or other reader systems.

Interface blocks 608/618/628 may communicate using any suitable wired or wireless means. For example, interface blocks 608/618/628 may communicate over circuit traces or interconnects, or other physical wires or cables, and/or using any suitable wireless signal propagation technique. In some examples, interface blocks 608/618/628 may communicate via an electronic communications network, such as a local area network (LAN), a metropolitan area network (MAN), a wide area network (WAN), a network of networks such as the internet. Communications from interface blocks 608/618/628 may be secured, for example via encryption and other electronic means, or may be unsecured.

Reader system 600 may be implemented in any suitable way. One or more of the components in reader system 600 may be implemented as integrated circuits using CMOS technology, BJT technology, MESFET technology, and/or any other suitable physical implementation technology. Components may also be implemented as software executing on general-purpose or application-specific hardware.

In one embodiment, a “reader” as used in this disclosure may include at least one reader module like reader module 602 and at least one local controller such as local controller 612. Such a reader may or may not include any remote controllers such as remote controller 622. A reader including a reader module and a local controller may be implemented as a standalone device or as a component in another device. In some examples, a reader may be implemented as a mobile device, such as a handheld reader, or as a component in a mobile device such as a laptop, tablet, smartphone, wearable device, or any other suitable mobile device.

Remote controller 622, if not included in a reader, may be implemented separately. For example, remote controller 622 may be implemented as a local host, a remote server, or a database, coupled to one or more readers via one or more communications networks. In some examples, remote controller 622 may be implemented as an application executing on a cloud or at a datacenter.

Functionality within reader system 600 may be distributed in any suitable way. For example, the encoding and/or decoding functionalities of blocks 604 and 606 may be performed by processor blocks 614 and/or 624. In some examples, processor blocks 614 and 624 may cooperate to execute an application or perform some functionality. One of local controller 612 and remote controller 622 may not implement memory, with the other controller providing memory.

Reader system 600 may communicate with at least one service 632. Service 632 provides one or more features, functions, and/or capabilities associated with one or more entities, such as reader systems, tags, tagged items, and similar. Such features, functions, and/or capabilities may include the provision of information associated with the entity, such as warranty information, repair/replacement information, upgrade/update information, and similar; and the provision of services associated with the entity, such as storage and/or access of entity-related data, location tracking for the entity, entity security services (e.g., authentication of the entity), entity privacy services (e.g., who is allowed access to what information about the entity), and similar. Service 632 may be separate from reader system 600, and the two may communicate via one or more networks.

In some examples, an RFID reader or reader system implements the functions and features described above at least partly in the form of firmware, software, or a combination, such as hardware or device drivers, an operating system, applications, and the like. In some examples, interfaces to the various firmware and/or software components may be provided. Such interfaces may include application programming interfaces (APIs), libraries, user interfaces (graphical and otherwise), or any other suitable interface. The firmware, software, and/or interfaces may be implemented via one or more processor blocks, such as processor blocks 614/624. In some examples, at least some of the reader or reader system functions and features can be provided as a service, for example, via service 632 or service 640.

In general, an RFID tag IC has or stores one or more identifiers, which as described above is a number or bit sequence that identifies the tag IC or associated item. The identifier may contain information about the tag IC or item (e.g., a TID or an EPC) or may be used to look up information about the tag IC or item. The tag IC identifier may uniquely identify (at least within the constraints of a finite-length identifier) or be used to uniquely identify the tag IC or associated item.

In some communication protocols, such as the Gen2 Protocol, an RFID tag IC will send its identifier to a requesting reader without having previously received correct verification information or verifying that the reader is authorized to receive information from the tag IC. For example, any reader can send a Gen2 Query command to cause all Gen2-compliant RFID tag ICs matching the flags specified in the command to queue and eventually respond with their identifiers.

The above feature, while useful from the standpoint of making sure all RFID tag ICs can be detected, may be problematic for the privacy-oriented, who may want to keep their RFID tag ICs anonymous. One way to address this issue is to have privacy modes for RFID tag ICs. When an RFID tag IC is in a privacy mode, it may not respond to inventorying commands from unverified readers, without associated correct verification information, or may only respond with limited information. For example, an RFID tag IC in a recycling-enabled privacy mode, described in more detail below, may respond with recycling information for the tag IC or associated item but not with other identifying information.

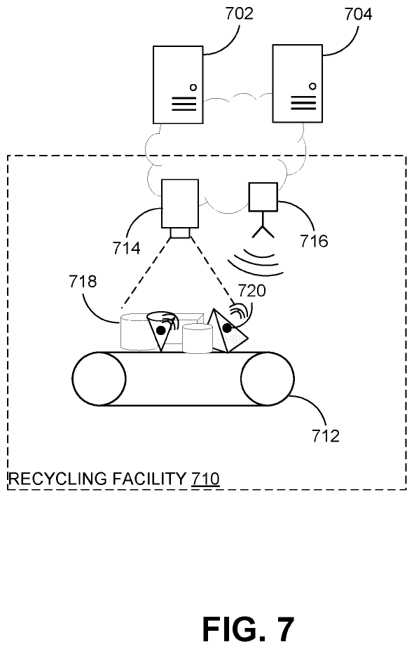

FIG. 7 depicts a recycling system, according to examples. FIG. 7 shows recycling system 700, which may include a recycling facility 710 with a conveyor system 712, a camera or optical capture system 714, an RFID reader 716, and potentially recyclable items 718 to be sorted, where at least some of the items 718 have associated RFID tags 720 that may be attached to or incorporated in the items 718. The camera 714 and the RFID reader 716 may be communicatively coupled to respective servers 702 and 704. Servers 702/704 may be located at facility 710 or may be remote. The recycling system 700 may be configured to sort items 718 based on relevant characteristics. For example, the recycling system 700 may sort based on item type or composition. The recycling system 700 may use the conveyor system 712 to sort items 718 into different containers and/or different processing streams. For example, the recycling system 700 may cause the conveyor system to direct items having a first composition to a first location and items having a second composition to a second location.

The recycling system 700 may be configured to identify and sort items 718 based on images captured by camera 714, information read by RFID reader 716, data received from other sensor(s), or any combination of the foregoing. In some examples, the recycling system 700 may include one or more controllers, processors, processing blocks, and/or servers configured to (a) receive information from camera 714, RFID reader 716, servers 702/704, and/or other associated sensors, (b) determine, based on item recyclability information, how items should be sorted, and/or (c) control the conveyor system 712 to sort the items accordingly.

The server 702 may implement a vision detection system configured to use images of the items 718 captured by the camera 714 to identify the recyclability of the items 718. The server 702 may represent one or more servers executing the vision detection system, which may include image processing, machine learning, sorting control, and other subsystems. Each of the subsystems may include software and/or hardware components such as processors, controllers, communication systems, etc. The vision detection system uses machine learning to determine information about item recyclability from item images. Such information may include the composition of an item, whether the item is recyclable, and if recyclable how the item can be recycled. In some examples, the information determined by the vision detection system about item recyclability may also or instead include the identity of the item or at least its classification, which can then be used to determine item recyclability. Once the vision detection system has determined information about item recyclability, it can notify the recycling system 700 (for example, by providing the determined item recyclability information), which can then seek additional item recyclability information and/or sort the item accordingly.

In some situations, captured optical images can be combined with available RFID tag or recycling information to help identify recyclable items and/or train the vision detection system. For example, the RFID reader 716 may retrieve information (“RFID tag information”) from the tags 720 as described above. The RFID tag information may or may not explicitly identify the associated items or material (for example, it may include the entirety or a portion of a tag or item identifier), but may include recycling-relevant information such as item classification, item composition, how an item is to be recycled or disposed of, or any other information helpful for determining recycling suitability but not uniquely identifying the associated item(s). In one example, the RFID tag information may include a Global Trade Item Number (GTIN), which identifies an item class but does not uniquely identify a particular item. In some situations, the RFID tag information may not itself include recycling-relevant information but can instead be used to look up recycling-relevant information, for example via an external entity such as server 704. For example, the RFID tag information may include at least portions of tag or item identifiers that can be used to look up recycling-relevant information about the tag or associated item.

When available, RFID-based recycling-relevant information (“RFID recycling information”) can be used to confirm and/or refute the visual recyclability determination made by the vision detection system. If the RFID recycling information refutes (i.e., does not match or correspond to) the visual recyclability determination, then the recycling system 700 may determine which to abide by and proceed accordingly. In some situations, RFID recycling information may be more accurate than the visual recyclability determination (for example, if items are misshapen or damaged), and if that is the case then the recycling system 700 may give precedence to the RFID recycling information.

When optical images and RFID tag and/or recycling information (individually or collectively, “RFID-derived information”) are both available for a given item, then the images and RFID-derived information may be used to train the machine learning algorithm(s) used by the vision detection system. For example, if the visual recyclability determination based on the optical images match the RFID-derived information, then the images and RFID-derived information may be used to further reinforce the machine learning algorithm's operation. On the other hand, if the visual recyclability determination does not match the RFID-derived information, then (assuming that the RFID-derived information is correct and takes precedence) the images and RFID-derived information can be used to train the machine learning algorithm to improve future visual recyclability determination.

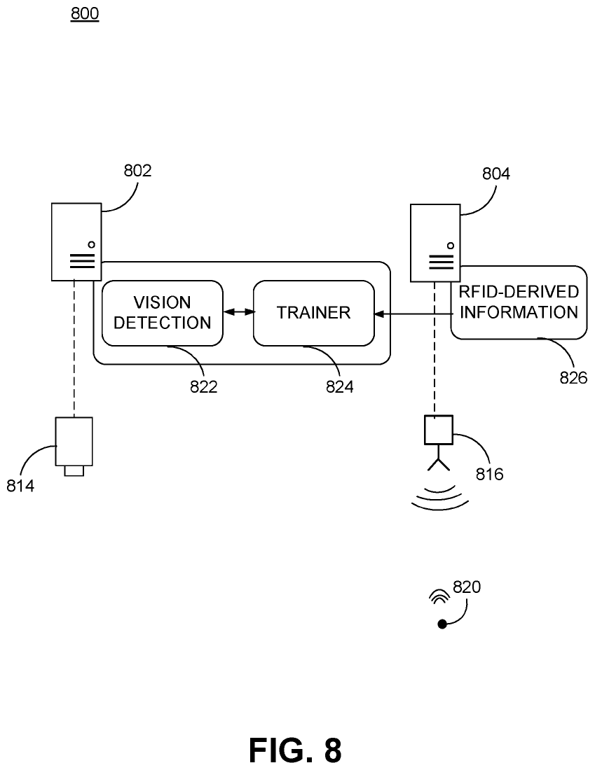

FIG. 8 depicts a block diagram of how RFID-derived information may be used to train machine learning algorithms for vision detection, according to examples. Diagram 800 depicts a vision detection server 802 configured to identify recyclable items based on captured images. The vision detection server 802 is configured to receive captured images of potentially recyclable items from a camera/optical capture system 814. The vision detection server 802 includes or implements a vision detection module 822, in hardware or software form, configured to determine whether the captured images from system 814 depict recyclable items, and if so what types of recyclable items. The vision detection module 822 may use one or more machine learning algorithms to perform the determinations. In one example, the vision detection module 822 uses a supervised learning algorithm. The machine learning portions of the vision detection module 822 may be trained by a trainer module 824, which may be implemented by the vision detection server 802 or by another entity. The trainer module 824 may be configured to train the machine learning portions of the vision detection module 822 using one or more data sets. For supervised learning examples, the trainer module 824 may use a training data set including various images of recyclable items and their associated identities, compositions, and/or classifications.

Diagram 800 also depicts an RFID server 804 configured to determine RFID-derived information 826, which includes RFID tag information and RFID recycling information. RFID server 804 is coupled to an RFID reader 816 configured to read or retrieve RFID tag information from RFID tags associated with potentially recyclable items. In diagram 800, RFID reader 816 retrieves RFID tag information from an RFID tag 820 associated with a potentially recyclable item. The RFID tag information may include an item identifier (IID), a tag identifier (TID), an electronic product code (EPC), a recycling code (e.g., a code indicating item composition and/or recyclability), or other information stored on the RFID tag 820. The RFID reader 816 may send the RFID tag information to RFID server 804, which in turn may use the RFID tag information to determine RFID recycling information related to RFID tag 820 and its associated item. In some examples, the RFID reader 816 or the RFID server 804 may communicate with a database server via a network and retrieve the RFID recycling information by providing the RFID tag information retrieved from RFID tag 820. In other examples, the RFID server 804 may implement the database. Communications between the RFID reader 816, the RFID server 804, and/or any database server may be secured, for example using encryption or digital signatures, or in plaintext or otherwise unsecured.

In some situations, the RFID tag information from the RFID tag 820 may already include RFID recycling information. In this case, the RFID server 804 may not be needed to determine RFID recycling information.

The RFID-derived information 826 may not uniquely identify the RFID tag 820 or its associated item but does provide information about the recyclability of tag 820 and/or its associated item. For example, the RFID-derived information 826 may include a recycling code or portions of an identifier such as the IID/TID/EPC sufficient to provide recycling information but insufficient to uniquely identify the tag/item.

In any event, the RFID-derived information 826 can be used in several ways. First, the RFID-derived information 826 can be used to check the current or most recent visual recyclable items determination performed by the vision detection module 822. For example, if the two do not correspond (i.e., the RFID-derived information 826 does not match the visual recyclable items determination), then the item may be diverted accordingly. In some examples, the recycling system may give precedence to the RFID-derived information 826, and therefore sort the item based on the RFID-derived information 826 and not the visual recyclable items determination. Second, the RFID-derived information 826 can be used in conjunction with the images captured by system 814 as training data for the vision detection module 822. For example, if the vision detection module 822 implements supervised learning algorithms, the trainer module 824 may train the supervised learning algorithms using the RFID-derived information 826 along with the captured images as part of a training data set or validation data set.

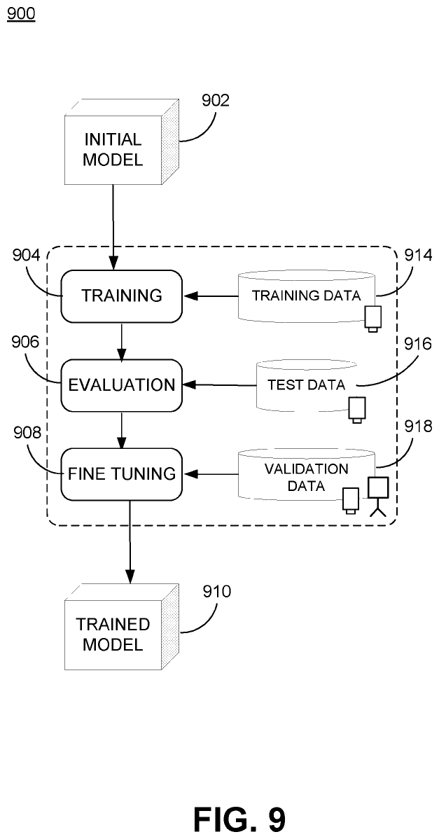

FIG. 9 depicts a diagram of RFID-assisted vision detection training for sorting recyclable items, according to one example. Diagram 900 in FIG. 9 shows how an initial vision detection model 902 may undergo three stages—training 904, evaluation 906, and fine tuning 908—to arrive at a trained model 910. The trained model 910 may be used in actual vision detection of recyclable items at a recycling facility and may also be periodically or continuously re-trained to increase accuracy. The initial model 902 may be any suitable vision detection model. Training 904 may include use of training data 914 such as images captured by a camera of the recycling facility or stock images (e.g., images of individual items such as cans, boxes, magazines, bottles, etc.) and their associated recyclability information (i.e., what kinds or classes of items they are, whether they are recyclable, what kind of materials they include, and/or how the items should be recycled if recyclable). Evaluation 906 may include testing of the initially trained model using test data 916. The test data 916 may also include images captured by a camera of the recycling facility or stock images. Fine tuning 908 may include adjustment of the tested model using validation data 918. The validation data 918 may include images of verified recyclable items, for example captured from a camera system such as system 814, and/or item recyclability information, such as information obtained through an RFID system.

Machine learning algorithms, which are part of artificial intelligence (AI), build a model based on sample data, or training data, in order to make predictions or decisions without being explicitly programmed to do so. Machine learning methods are commonly divided into three broad categories, depending on the type of feedback received by the learning system: supervised learning, unsupervised learning, and reinforcement learning. Supervised learning uses example inputs and corresponding desired outputs to generate a general rule that maps inputs to outputs. Unsupervised learning relies on detecting patterns in data without example input-output pairs. Reinforcement learning provides feedback to a machine learning algorithm as it navigates the data set(s). Logistic Regression and Neural Network Back Propagation are examples of supervised learning, which typically uses iterative optimization of an objective function. Apriori algorithms and K-Means are examples of unsupervised learning, which may utilize clustering, dimensionality reduction, and association rule learning. There are also a mixture of supervised and unsupervised learning (semi-supervised learning) algorithms, where the input data is a mixture of labeled and unlabeled examples. Reinforcement learning algorithms may start with a Markov decision process.

The model in machine learning, which is trained using training data and then can process additional data, may also vary depending on the algorithm and/or type of data being processed. Example models include artificial neural networks, decision trees, regression models, and Bayesian networks. Deep learning algorithms are a recent development related to artificial neural networks. Deep learning algorithms build larger and more complex neural networks and are used for image or video processing. Popular deep learning algorithms include Convolutional Neural Networks (CNNs), Recurrent Neural Networks (RNNs), Long Short-Term Memory Networks (LSTMs), Stacked Auto-Encoders, Deep Boltzmann Machine (DBM), and Deep Belief Networks (DBN).

As mentioned above, the selected model in the selected machine learning algorithm may be trained and fine-tuned using validation data derived from item recyclability information, which may include an identification of a particular recyclable item, recycling information associated with the recyclable item (e.g., how the item is to be recycled), or information about items that are not recyclable or cannot be recycled.

In some examples, training or fine-tuning the vision detection model means training the vision detection system to identify particular recyclable items based on RFID-derived information originating from RFID tags associated with the items. If the same item or type of item is encountered, but without an RFID tag (e.g., the RFID tag may be broken or removed), the vision detection system may still be able to identify the item because it has already been trained to recognize the item or type of item. Similarly, if an item is misshapen or damaged but retains its RFID tag, then even if the vision detection system cannot identify the item, it can be recycled based on RFID tag information read from the RFID tag. In this situation, the image(s) of the misshapen/damaged item and the RFID-derived information can then be used to further train the vision detection system.

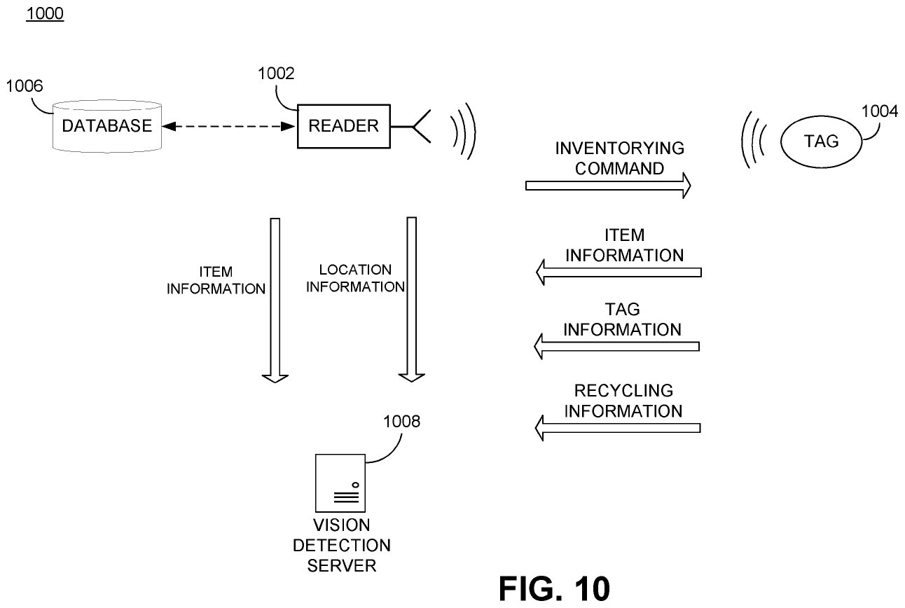

FIG. 10 illustrates interactions between an RFID reader and an RFID tag in possible modes including a recycling-enabled privacy mode, according to examples. Diagram 1000 depicts an RFID reader 1002 wirelessly communicating with an RFID tag 1004 to retrieve information from the tag. In response to an inventorying command (e.g., a Query command according to the Gen2 Protocol) from the RFID reader 1002, the RFID tag 1004 may provide RFID tag information, such as item information, tag information, and/or recycling information. The received information may already include item identification information or recycling information—if not the RFID reader 1002 may use the received RFID tag information to retrieve the item identification information/recycling information from a database 1006. In some examples, the RFID reader 1002 may also estimate a location of the RFID tag 1004, use the received/retrieved information and the estimated location to sort the associated item, and/or provide the information/estimated location to a vision detection server 1008 to be used as validation data in training a vision detection model. In some examples, RFID tag location can be useful for distinguishing between different items that may be present in an image captured by a camera (e.g., camera 814). In other examples, an RFID reader such as the RFID reader 1002 may be constrained to only read RFID tags in specific locations, to avoid reading stray tags outside those captured in images.

As mentioned previously, some tags may be in a public mode, where they may provide information to any RFID reader. In other examples, a tag may be additionally configured with a privacy mode, in which it may not provide certain information to an RFID reader without first authenticating the reader. For example, the RFID reader may authenticate itself by providing a passcode to the tag or somehow indicating its knowledge of a secret associated with the tag before the tag will provide item, tag, or similar information. In some examples, the tag may be associated with a cryptographic key, and the RFID reader may send a message to the tag including a cryptographic result based on the tag's cryptographic key.

In yet other examples, an RFID tag additionally configured with a privacy mode may include, as part of the privacy mode, a recycling information mode. When in the recycling information mode, the RFID tag may provide information sufficient to determine recycling information about it or its associated item to readers without requiring authentication, even if the RFID tag is otherwise in the privacy mode. An RFID tag may indicate or track whether it is in a recycling information mode using any suitable way. In one example, an RFID tag may implement a recycling indicator bit, where the bit is asserted (e.g., has a “1” value) when the RFID tag is in the recycling information mode and unasserted (e.g., has a “0” value) otherwise. In this example, an RFID tag with an unasserted recycling indicator bit will not respond to any inventorying commands from unauthenticated RFID readers, whereas an RFID tag with an asserted recycling indicator bit will respond to inventorying commands from unauthenticated RFID readers if a preceding selection command (e.g., a Select command according to the Gen2 Protocol) specifically indicates (“selects on”) the asserted recycling indicator bit. In the latter case, the RFID tag is in a “recycling-enabled privacy mode”.

A recycling information mode indicator (“recycling indicator”) may be implemented in any suitable way. In one example, a “nonremovable” indicator such as the NR bit described in the Gen2 Protocol may serve as a recycling indicator. In other examples, recycling indicators may be longer than a single bit, and could be part of a tag or item identifier. In this instance, a recycling indicator is “asserted” if it indicates that the RFID tag is in the recycling-enabled privacy mode described above, even if the recycling indicator is longer than one bit.

Referring back to diagram 1000, if tag 1004 is in a recycling-enabled privacy mode as described above, the RFID reader 1002 may first transmit a selection command specifying asserted recycling indicators and then transmit an inventorying command. Since tag 1004 is in the recycling-enabled privacy mode, it will respond with information sufficient to determine its (and/or its item's) recycling information. In one example, tag 1004 may itself provide the recycling information. In another example, tag 1004 provides a partial identifier, such as an item class, that can be used to determine recycling information but is insufficient to uniquely identify tag 1004 or its associated item.

RFID recycling information may describe how an RFID tag and/or its associated item can be recycled or disposed of. RFID recycling information may include item or tag composition, precautions to take during recycling or disposal, and any other information necessary for safe recycling or disposal. For example, one RFID tag's recycling information may indicate that it or its associated item is “paper”, whereas another RFID tag's recycling information may indicate that it or its associated item is “cotton”. In some examples, an RFID tag's recycling information may indicate where additional recycling or disposal information can be found. For example, the recycling information may include an address or a link (e.g., a uniform resource locator or similar) to a network location or service. A recycler may then obtain additional recycling/disposal information for the item from the specified network location or service.

In some examples, a tag may be configured to allow its owner to decide whether to enable recycling-enabled privacy modes. For example, a tag owner may not want the tag to respond to unauthenticated readers in any situation, even for disposal purposes. In this case, the tag owner can keep the tag's recycling indicator unasserted, and the tag will not participate in any inventorying by unauthenticated readers. This allows the tag owner to exert more control over how the tag responds (or doesn't respond).

While in the above a reader elicits RFID tag information from tags by first transmitting a selection command specifying asserted recycling indicators and then transmitting an inventorying command, in other examples a reader may elicit RFID tag information in any suitable way. For example, a reader may transmit an inventorying command that specifies asserted recycling indicators, and tags with asserted recycling indicators may respond with RFID tag information, regardless of whether the reader was authenticated.

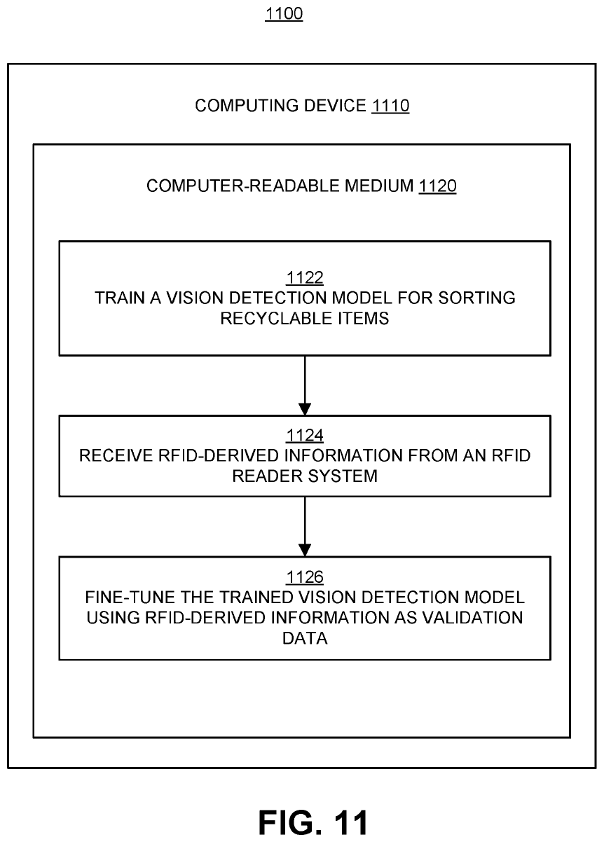

FIG. 11 is a flow diagram illustrating an example method for RFID-assisted training of vision-detection-based sorting of recyclable items, where the vision detection system is trained with supplemental information from RFID tags on some recyclable items, according to examples.

Example methods for training of vision-detection-based systems with supplemental information from RFID tags on some recyclable items for sorting of recyclable items may include one or more operations, functions or actions as illustrated by one or more of blocks 1122, 1124, and/or 1126. The operations described in blocks 1122 through 1126 may also be stored as computer-executable instructions in a computer-readable medium such as a computer-readable medium 1120 of a computing device 1110.

A process for training of vision-detection-based systems with supplemental information from RFID tags on some recyclable items may begin with block 1122, “TRAIN A VISION DETECTION MODEL FOR SORTING RECYCLABLE ITEMS.” At block 1122, a vision detection model (e.g., a standard model) for identification of individual recyclable items at a sorting facility may be trained. Training data sets including images of recyclable items captured by a camera of the facility or stock images (e.g., cans, bottles, boxes, magazines, etc.) and corresponding recycling information or item identification may be used for the initial training of the model. In some examples, the model may be evaluated using test data (e.g., images of known recyclable and nonrecyclable items).

Block 1122 may be followed by block 1124, “RECEIVE RFID-DERIVED INFORMATION FROM AN RFID READER SYSTEM.” At block 1124, an RFID reader may interrogate RFID tags on some of the individual recyclable items and retrieve RFID tag information, which may include tag, item, or recycling information. The RFID reader may also retrieve RFID recycling information such as item identification information or recycling instructions (which may simply be a code) from a database using the retrieved RFID tag information. The RFID reader may then provide the RFID-derived information to the vision detection system to be used as part of validation data.

Block 1124 may be followed by block 1126, “FINE-TUNE THE TRAINED VISION DETECTION MODEL USING RFID-DERIVED INFORMATION AS VALIDATION DATA.” At block 1126, the vision detection system may fine-tune the trained model using the received RFID-derived information, along with captured images, as validation data. The RFID-derived information from the RFID reader may enhance vision detection accuracy.

The blocks included in the above-described processes are for illustration purposes. RFID-assisted training of vision-detection-based sorting of recyclable items may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

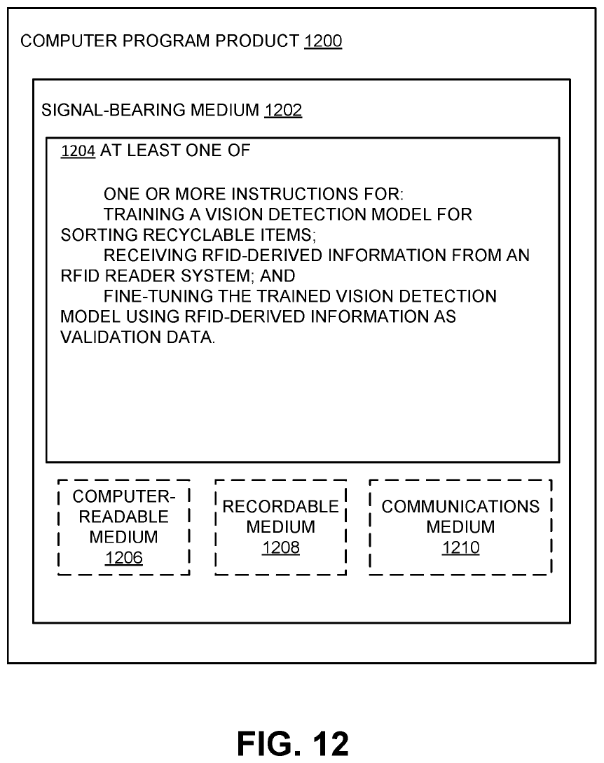

FIG. 12 illustrates a block diagram of an example computer program product, according to examples. In some examples, as shown in FIG. 12, a computer program product 1200 may include a signal bearing medium 1202 that may also include machine readable instructions 1204 that, when executed by, for example, a processor, may provide the functionality described above with respect to FIG. 7 through FIG. 10. Thus, for example, referring to FIG. 8, the vision detection server 802 and the RFID server 804 may undertake one or more of the tasks shown in FIG. 12 in response to the instructions 1204 conveyed to the servers by the signal bearing medium 1202 to perform actions associated with the processes as described herein. Some of those instructions may include training a vision detection model for sorting recyclable items, receiving RFID-derived information from an RFID reader system, and fine-tuning the trained vision detection model using RFID-derived information as validation data.

In some implementations, the signal bearing medium 1202 depicted in FIG. 12 may encompass a computer-readable medium 1206, such as, but not limited to, a hard disk drive, a Compact Disc (CD), a Digital Versatile Disk (DVD), a digital tape, memory, etc. In some implementations, the signal bearing medium 1202 may encompass a recordable medium 1208, such as, but not limited to, memory, read/write (R/W) CDs, R/W DVDs, etc. In some implementations, the signal bearing medium 1202 may encompass a communications medium 1210, such as, but not limited to, a digital and/or an analog communication medium (e.g., a fiber optic cable, a waveguide, a wired communications link, a wireless communication link, etc.). Thus, for example, the program product 1200 may be conveyed to one or more modules of the server 802 by an RF signal bearing medium, where the signal bearing medium 1202 is conveyed by a wireless communications medium 1210 (e.g., a wireless communications medium conforming with the IEEE 802.11 standard).

According to some examples, a recycling-material sorting system may include an image capture system configured to capture images of potentially recyclable items; an RFID reader system configured to communicate with RFID ICs associated with the items; a vision detection system configured to identify item classes from the images of the items based on at least one supervised learning algorithm; and a controller. The controller may be configured to receive, from the RFID reader system, a first item identifier for a first potentially recyclable item, where the RFID reader system retrieves the first item identifier from an RFID IC associated with the first item, and the first item identifier indicates at least a first item class for the first item. The controller may further receive, from the image capture system, a first image of the first item captured by the image capture system; provide training set data including the first item class and the first image to the vision detection system for training the supervised learning algorithm; receive, from the image capture system, a second image of a second potentially recyclable item; provide the second image to the vision detection system, wherein the vision detection system identifies the first item class from the second image and provides the identified first item class to the controller; and use at least the identified first item class to determine recycling information for the second item.

According to other examples, the first item identifier may include the first item class or is used to derive the first item class. The controller may be further configured to derive the first item class from the first item identifier using a database. The first item class may include the recycling information. The first item class may be a Global Trade Item Number (GTIN). The first item identifier may be shared among multiple items and therefore may not uniquely identify the first item. The controller may be further configured to, if the RFID reader system retrieves a second item identifier from a second RFID IC associated with the second item, receive the second item identifier; use at least the identified first item class and the second item identifier to determine the recycling information; and include the second image and an item class derived from the second item identifier in the training set data provided to the vision detection system. The recycling information may indicate at least one of whether the second item is recyclable; and a composition of the second item. The RFID reader system may select on a recycling indicator before retrieving the first item identifier from the RFID IC.

According to further examples, a method for recycling-material sorting system may include capturing images of potentially recyclable items through an image capture system; communicating with RFID ICs associated with the potentially recyclable items through an RFID reader system; identifying item classes from the images of the potentially recyclable items based on at least one supervised learning algorithm through a vision detection system; and, through a controller, receiving, from the RFID reader system, a first item identifier for a first potentially recyclable item, where the RFID reader system retrieves the first item identifier from an RFID IC associated with the first item, and the first item identifier indicates at least a first item class for the first item. The method may also include, through the controller, receiving, from the image capture system, a first image of the first item captured by the image capture system; providing training set data including the first item class and the first image to the vision detection system for training the supervised learning algorithm; receiving, from the image capture system, a second image of a second potentially recyclable item; providing the second image to the vision detection system, where the vision detection system identifies the first item class from the second image and provides the identified first item class to the controller; and using at least the identified first item class to determine recycling information for the second item.

According to some examples, a recyclable material sorting system may include a Radio Frequency Identification (RFID) reader system configured to communicate with RFID tags; an image capture system configured to capture images of items; and a controller communicatively coupled to the RFID reader system and the image capture system. The controller may be configured to receive, from the RFID reader system, identifying information from an RFID tag associated with an item; determine, based on the identifying information, first recycling information for the item; receive, from the image capture system, an image of the item; and attempt to determine second recycling information for the item using a supervised learning vision detection system and the image. The controller may, upon successfully determining the second recycling information, cause the item to be sorted based on at least one of the first recycling information and the second recycling information; and use a first correspondence between the first recycling information and the second recycling information to train the supervised learning vision detection system. The controller may, upon failing to determine the second recycling information, cause the item to be sorted based on the first recycling information; and use a second correspondence between the first recycling information and the image to train the supervised learning vision detection system.

According to other examples, the controller may implement the supervised learning vision detection system or may be coupled to the supervised learning vision detection system. The first correspondence may be either a match or a mismatch between the first recycling information and the second recycling information; and the controller may be further configured to, if the first correspondence is a match then provide the first recycling information and the image as validation data for training the supervised learning vision detection system; and if the first correspondence is a mismatch then provide the first recycling information and the image as training data for training the supervised learning vision detection system. If the first correspondence is a mismatch between the first recycling information and the second recycling information, then the controller may be further configured to cause the item to be sorted based on the first recycling information. The controller may be configured to cause the item to be sorted by at least one of causing the item to be physically sorted and causing the item to be classified based on an item recyclability. The identifying information may include or is used to derive an item class of the item. The item class may include the first recycling information. The item class may be a Global Trade Item Number (GTIN).

As mentioned previously, examples are directed to RFID-assisted vision detection training for sorting recyclable items. Examples additionally include programs, and methods of operation of the programs. A program is generally defined as a group of steps or operations leading to a desired result, due to the nature of the elements in the steps and their sequence. A program is usually advantageously implemented as a sequence of steps or operations for a processor but may be implemented in other processing elements such as FPGAs, DSPs, or other devices as described above.

Performing the steps, instructions, or operations of a program requires manipulating physical quantities. Usually, though not necessarily, these quantities may be transferred, combined, compared, and otherwise manipulated or processed according to the steps or instructions, and they may also be stored in a computer-readable medium. These quantities include, for example, electrical, magnetic, and electromagnetic charges or particles, states of matter, and in the more general case can include the states of any physical devices or elements. Information represented by the states of these quantities may be referred-to as bits, data bits, samples, values, symbols, characters, terms, numbers, or the like. However, these and similar terms are associated with and merely convenient labels applied to the appropriate physical quantities, individually or in groups.

Examples furthermore include storage media. Such media, individually or in combination with others, have stored thereon instructions, data, keys, signatures, and other data of a program made according to the examples. A storage medium according to examples is a computer-readable medium, such as a memory, and can be read by a processor of the type mentioned above. If a memory, it can be implemented in any of the ways and using any of the technologies described above.

Even though it is said that a program may be stored in a computer-readable medium, it does not need to be a single memory, or even a single machine. Various portions, modules or features of it may reside in separate memories, or even separate machines. The separate machines may be connected directly, or through a network such as a local access network (LAN) or a global network such as the Internet.

Often, for the sake of convenience only, it is desirable to implement and describe a program as software. The software can be unitary or thought of in terms of various interconnected distinct software modules.

The foregoing detailed description has set forth various examples of the devices and/or processes via the use of block diagrams and/or examples. Insofar as such block diagrams and/or examples contain one or more functions and/or aspects, each function and/or aspect within such block diagrams or examples may be implemented individually and/or collectively, by a wide range of hardware, software, firmware, or virtually any combination thereof. Some aspects of the examples disclosed herein, in whole or in part, may be equivalently implemented employing integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular examples described in this application, which are intended as illustrations of various aspects. Many modifications and variations can be made without departing from its spirit and scope. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, configurations, tags, RFICs, readers, systems, and the like, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). Any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. All language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

1. A recycling-material sorting system comprising:
an image capture system configured to capture images of potentially recyclable items;
a radio frequency identification (RFID) reader system configured to communicate with RFID integrated circuits (ICs) associated with the items;
a vision detection system configured to identify item classes from the images of the items based on at least one supervised learning algorithm; and
a controller configured to:
receive, from the RFID reader system, a first item identifier for a first potentially recyclable item, wherein:
the RFID reader system retrieves the first item identifier from an RFID IC associated with the first item, and
the first item identifier indicates at least a first item class for the first item;
receive, from the image capture system, a first image of the first item captured by the image capture system;
provide training set data including the first item class and the first image to the vision detection system for training the supervised learning algorithm;
receive, from the image capture system, a second image of a second potentially recyclable item;
provide the second image to the vision detection system, wherein the vision detection system identifies the first item class from the second image and provides the identified first item class to the controller; and
use at least the identified first item class to determine recycling information for the second item.

2. The system of claim 1, wherein the first item identifier includes the first item class or is used to derive the first item class.

3. The system of claim 2, wherein the controller is further configured to derive the first item class from the first item identifier using a database.

4. The system of claim 1, wherein the first item class includes the recycling information.

5. The system of claim 1, wherein the first item class is a Global Trade Item Number (GTIN).

6. The system of claim 1, wherein the first item identifier is shared among multiple items and therefore does not uniquely identify the first item.

7. The system of claim 1, wherein the controller is further configured to, if the RFID reader system retrieves a second item identifier from a second RFID IC associated with the second item:
receive the second item identifier;
use at least the identified first item class and the second item identifier to determine the recycling information; and
include the second image and an item class derived from the second item identifier in the training set data provided to the vision detection system.

8. The system of claim 1, wherein the recycling information indicates at least one of:
whether the second item is recyclable; and
a composition of the second item.

9. The system of claim 1, wherein the RFID reader system selects on a recycling indicator before retrieving the first item identifier from the RFID IC.

10. A method for a recycling-material sorting system, the method comprising:
capturing images of potentially recyclable items through an image capture system;
communicating with radio frequency identification (RFID) integrated circuits (ICs) associated with the potentially recyclable items through an RFID reader system;
identifying item classes from the images of the potentially recyclable items based on at least one supervised learning algorithm through a vision detection system; and
through a controller:
receiving, from the RFID reader system, a first item identifier for a first potentially recyclable item, wherein:
the RFID reader system retrieves the first item identifier from an RFID IC associated with the first item, and
the first item identifier indicates at least a first item class for the first item;
receiving, from the image capture system, a first image of the first item captured by the image capture system;
providing training set data including the first item class and the first image to the vision detection system for training the supervised learning algorithm;
receiving, from the image capture system, a second image of a second potentially recyclable item;
providing the second image to the vision detection system, wherein the vision detection system identifies the first item class from the second image and provides the identified first item class to the controller; and
using at least the identified first item class to determine recycling information for the second item.
